(19) United States
(12) Patent Application Publication
(10) Pub. No.: US 2013/0171492 A1
(43) Pub. Date: Jul. 4, 2013

(54) BATTERY PACK

(71) Applicants: Chih-Cho Shih, Tainan City (TW); Chin-Chuan Chang, New Taipei City (TW); Sheng-Fa Yeh, Miaoli County (TW); Li-Lun Liu, Kaohsiung City (TW); Shih-Wei Wu, Keelung City (TW)

(72) Inventors: Chih-Cho Shih, Tainan City (TW); Chin-Chuan Chang, New Taipei City (TW); Sheng-Fa Yeh, Miaoli County (TW); Li-Lun Liu, Kaohsiung City (TW); Shih-Wei Wu, Keelung City (TW)

(73) Assignee: Industrial Technology Research Institute, Hsinchu (TW)

(21) Appl. No.: 13/585,814

(22) Filed: Aug. 14, 2012

(30) Foreign Application Priority Data
Dec. 29, 2011 (TW) 100149640

(51) Int. Cl. H01M 2/02; H01M 10/50

(52) U.S. Cl. 429/120; 429/156

(57) ABSTRACT

A packaging structure, packaging material and a packaging method for a battery pack including multiple battery cell units, multiple conductive units and one or more packaging materials are provided. The conductive units are electrically connected to the battery cell units. The packaging material is filled to gaps between the battery cell units and tightly bonded to surfaces of the battery cell units. The battery pack has an integrated structure. Therefore, the battery cell units do not move relative to each other, and breaking of connections between the battery cell units and a conductive metal line or sheet can be avoided.

### CROSS-REFERENCE TO RELATED APPLICATION

This application claims the priority benefit of Taiwan application serial no. 100149640, filed on Dec. 29, 2011. The entirety of the above-mentioned patent application is hereby incorporated by reference herein and made a part of this specification.

### BACKGROUND

1. Technical Field

The disclosure relates to a packaging structure, a packaging material, and a packaging method of a battery pack.

2. Related Art

As the decrease of the oil reserves and rise of the oil price become a global problem, an electric vehicle is an optimal solution at present. In California, U.S., the law is established to force the car dealers to sell a specific percentage of electric cars, and other states are preparing to follow up. Countries such as France, Germany, Switzerland, and Japan all have related policies to encourage and reward the use and the technology research and development of electric vehicles. Moreover, the electric vehicles of practicability are gradually developed, and are being promoted through experimental tryout. The introduction of a lithium battery plays an important role in the success of the electric vehicle development. The lithium battery weighs half of a nickel-metal-hydride battery (NiMH battery), while the endurance thereof is twice of the NiMH battery. In addition, the lithium battery has advantages of a high working voltage, a large energy density, and a long service life, as well as being environmental-friendly. The lithium battery does not emit waste gas during a driving process, which not only saves energy and reduces carbon emission, but also reduces oil consumption. In the future, replacing the NiMH battery with the rechargeable lithium battery is an irresistible trend for big car manufacturers.

In a battery pack, usually a cell holder is used to control gaps between battery cell units, so as to provide a structural strength that resists an external impact. The battery cell units are then connected by metal sheets through welding. In terms of the structure, the most difficult problem to overcome is the impact and vibration. In particular, the electric vehicle needs to confront a vibrating environment during driving on the road. This is one of the most important problems for the application of a mobile energy-storing battery system. A failure of such vehicle battery pack usually occurs at a welding point between the battery cell units and the cascaded/parallel metal sheets. From the perspective of a mass connection model, such welding is equivalent to connecting multiple heavy objects (battery cells) to metal sheets. When the battery pack is under an external force, the battery cell units therein are likely to move asynchronously. The connection points between the battery cell units and the metal sheets often break off or fracture due to a stress thereon. As a result, the battery cell units that break off do not participate in the power supply during an operation process, which is demonstrated as an attenuation of a battery capacity. Moreover, due to different voltages and capacities, a sparkle may be generated by a battery cell unit with a connection point that breaks off or of poor contact during operation due to intermittent vibrating contact. Once the arc sparkle causes a welding short circuit in the battery, the safety of the whole battery pack is endangered.

### SUMMARY

The disclosure is directed to a packaging structure, a packaging material, and a packaging method of a battery pack, which are capable of solving a problem of fixing each battery cell unit in the battery pack. The battery cell units are tightly bonded to form a whole through the packaging material, providing a highly stable structure that resists vibration, improving reliability of the structure of the battery pack, and providing a more desirable battery pack safety. The packaging material has an efficacy of heat conduction and heat dissipation, and can provide functions of heat dissipation and heat soaking for the battery pack at the same time.

The battery pack of the disclosure includes multiple battery cell units, multiple conductive units, and one or more packaging materials. The conductive units are electrically connected to the battery cell units. The packaging material is filled to gaps between the battery cell units and tightly bonded to surfaces of the battery cell units.

Based on the above, in the battery pack of the disclosure, the battery cell units are tightly bonded to each other by the packaging material, and therefore do not move relative to each other, which guarantees the reliability of connections between the battery cell units. The structural strength and stress of the connections between the battery cell units are mostly changed to be borne by the packaging material. The conductive units are no longer a main bearing member of the structural strength and stress of the connections between the battery cell units.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a sectional side view of a battery pack according to an embodiment of the disclosure.

FIG. 2 is a sectional side view of a battery pack according to another embodiment of the disclosure.

FIG. 3 is a sectional top view of the battery pack of FIG. 1 at a packaging material.

FIG. 3A is a sectional top view of a battery pack according to another embodiment of the disclosure.

FIG. 4 is a sectional top view of a battery pack according to still another embodiment of the disclosure.

FIG. 4A is a sectional top view of a battery pack according to another embodiment of the disclosure.

FIG. 5 is a sectional side view of the battery pack of FIG. 4.

### DETAILED DESCRIPTION OF DISCLOSED EMBODIMENTS

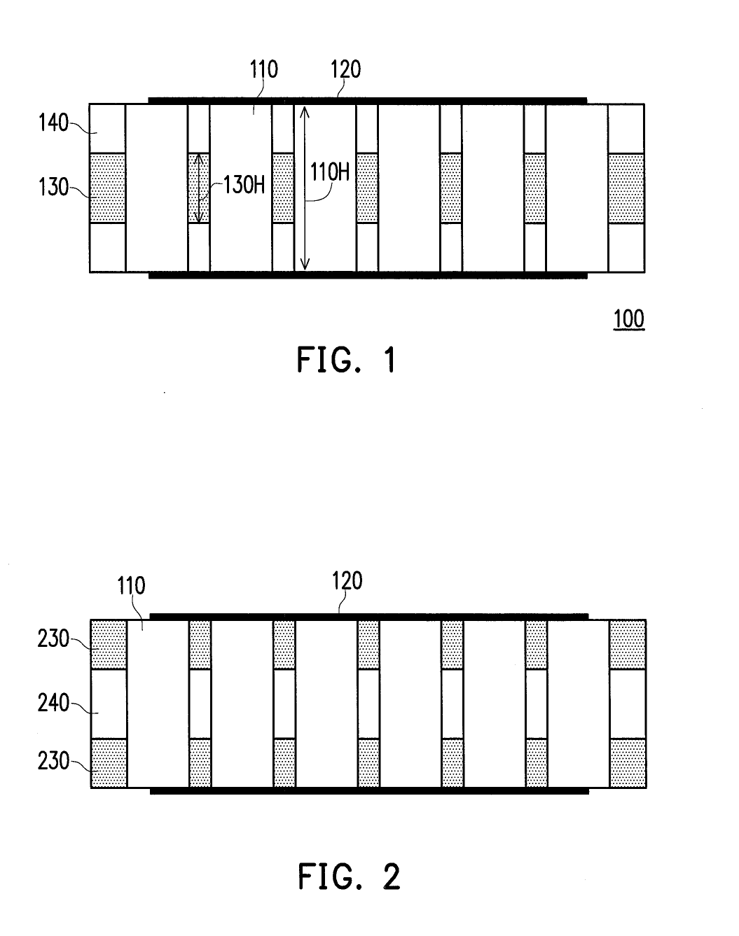

FIG. 1 is a sectional side view of a battery pack according to an embodiment of the disclosure. Referring to FIG. 1, in this embodiment, the battery pack 100 includes multiple battery cell units 110, multiple conductive units 120, and one or more packaging materials 130. The conductive units 120 are connected to the battery cell units 110. The packaging material 130 is filled to gaps between the battery cell units 110 and tightly bonded to surfaces of the battery cell units 110. For example, the packaging material 130 may function as a common bonding material and tightly bond the battery cell units 110 together. Therefore, the battery pack 100 of this embodiment forms an integrated structure by using the packaging material 130. The battery cell units 110 do not move relative to each other, thereby guaranteeing the reliability of the electrical connection between the conductive units 120 and the battery cell units 110. In this way, the connection reliability of all the battery cell units 110 is guaranteed. Furthermore, the reliability of the battery pack 100 is improved, and therefore more desirable electricity reliability and service life are provided. In addition, the packaging material 130 provides a tightly bonded and fixed connection structure of the battery pack 100, preventing relative motion of the battery cell units 110 which results in breaking off or poor contact of welding points between the battery cell units 110 and the conductive units 120 and decreases an electrical property of the battery pack 100, as the battery pack 100 is under an external force. If a battery cell unit 110 that breaks off or is of poor contact contacts a conductive unit 120 again, a sparkle may be generated in the battery pack 100, and thereby the safety of the battery pack 100 is affected.

In this embodiment, the battery cell units 110 may be, for example, 18650 battery cell units, or the other battery cell units. In this embodiment, the battery cell units 110 are in a shape of a cylinder a square column, and are arranged vertically in an array. A thickness 130H of the packaging material 130 between the battery cell units 110 may be, for example, larger than or equal to 50% of a height 110H of the battery cell units 110. In this embodiment, the conductive units 120 include multiple metal sheets welded between the battery cell units 110, for example, copper sheets, nickel sheets, aluminium sheets, or the other metal sheets. According to requirements, the conductive units 120 cascade and/or parallel the battery cell units 110 to each other.

In this embodiment, the battery pack 100 further includes at least one gap control member 140, configured between the battery cell units 110. Components of the packaging material 130 of this embodiment include reactive resin, and a Phase Change Material (PCM) microcapsule or a composite material with PCM inside. In other words, an initial state of the packaging material 130 of this embodiment is a liquid state or a pasty state. The packaging material 130 is tightly bonded to the surfaces of the battery cell units 110 after being cured in a thermal curing manner, an optical curing manner, or the other manners. The reactive resin may be, for example, epoxy resin, unsaturated polyester, vinylester, polyurethane, phenolic resin, or the other resin. Before the packaging material 130 is cured, the gap control member 140 may fix relative positions of the battery cell units 110. After the packaging material 130 is cured, the gap control members 140 may be kept in or be removed from the battery pack 100. Referring to the embodiment shown in FIG. 1, the packaging material 130 is located in middle segments of the battery cell units 110. The gap control members 140 are located in upper and lower segments of the battery cell units 110. Referring to the embodiment shown in FIG. 2, the packaging material 230 is located in upper and lower segments of the battery cell units 110, and the gap control members 240 are located in middle segments of the battery cell units 110.

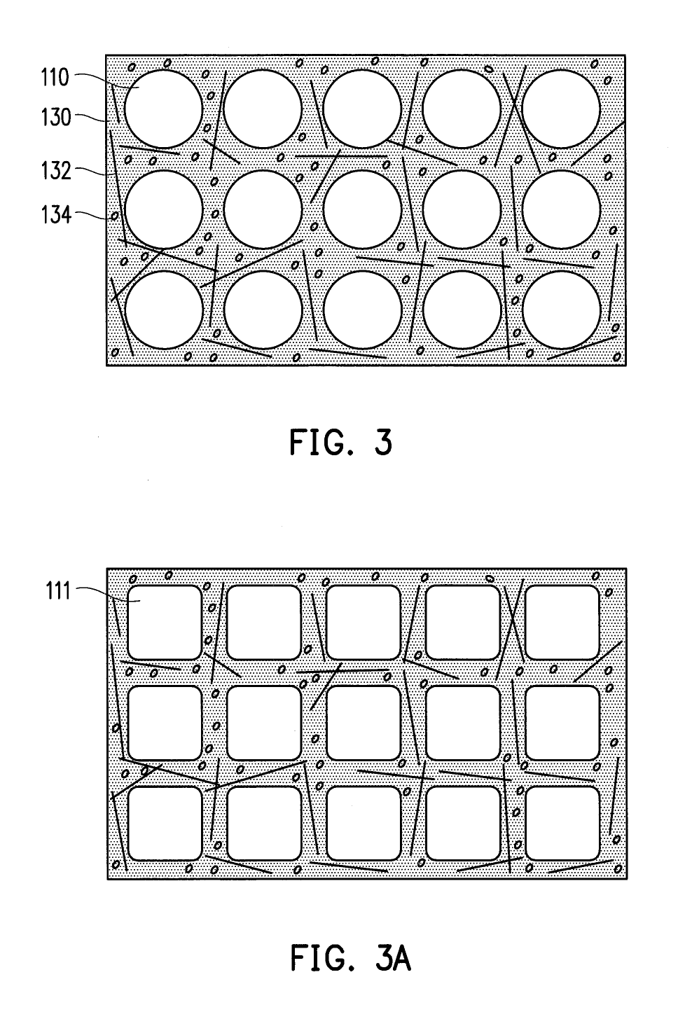

FIG. 3 is a sectional top view of the battery pack of FIG. 1 at the packaging material. Referring to FIG. 3, components of the packaging material 130 may further include structure strengthening fibres 132 and/or elastic compressing particles 134. The structure strengthening fibres 132 are used to further enhance the structural strength of the packaging material 130. The structure strengthening fibres 132 may also be a material with a high heat conducting capacity to increase the heat dissipating efficiency of the battery pack 100. The elastic particles 134 may absorb an impact force when the battery pack 100 is under an impact. FIG. 3A is another embodiment of the battery pack of FIG. 1 adopting battery cell units 111 in the shape of square column.

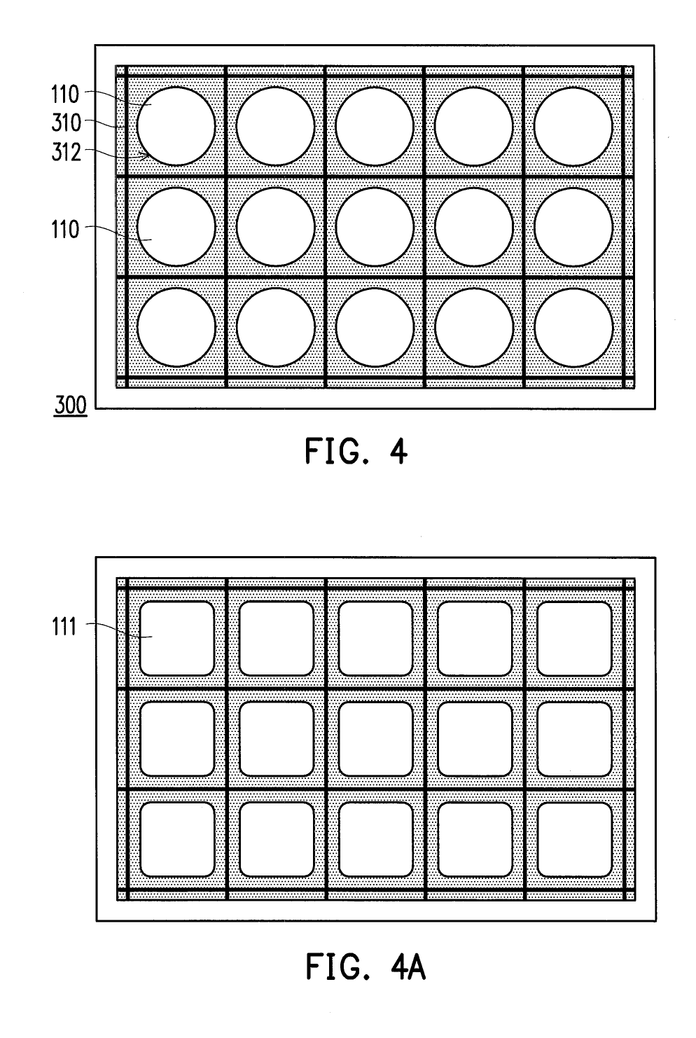

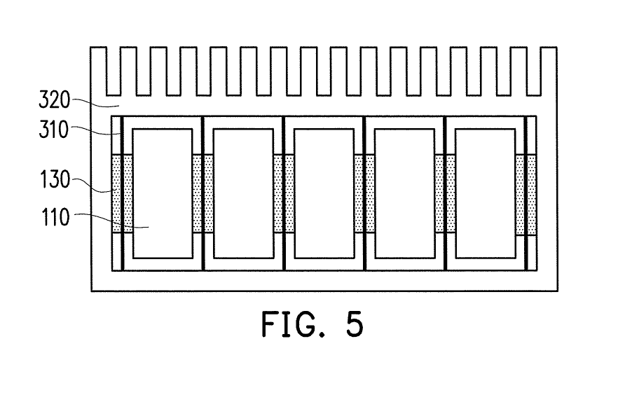

FIG. 4 is a sectional top view of a battery pack according to another embodiment of the disclosure. FIG. 5 is a sectional side view of the battery pack of FIG. 4. Referring to FIG. 4 and FIG. 5, in this embodiment, a battery pack 300 is similar to the battery pack 100 shown in FIG. 1. The difference is described in the following. The battery pack 300 of this embodiment further includes a grid 310 and a heatsink 320. The grid 310 is buried in the packaging material 130. Each mesh 312 of the grid 310 is configured with one battery cell unit 110. The grid 310 may enhance the structural strength of the packaging material 130. Moreover, when the grid 310 is manufactured by using material with a high heat conducting capacity, the heat dissipating efficiency of the battery pack 300 is increased. In this embodiment, the heatsink 320 is connected to the grid 310, so that the heat transmitted from the grid 310 is rapidly radiated to the outside through the heatsink 320. The heatsink 320 may be, for example, a metal housing wrapping the whole battery pack 300. In addition, the packaging material 130 is tightly bonded to the surfaces of the battery cell units 110, so the heat emitted by the battery cell units 110 is rapidly conducted to the packaging material 130 without being accumulated at the battery cell units 110, and is further conducted to the housing heatsink 320 of the battery pack 300 to be radiated. On the contrary, the battery cell units are disposed in slots preformed in the resin material in the prior art. The air and the battery cell units become a major thermal resistance source between the battery cell units and the resin material. FIG. 4A is another embodiment of the battery pack of FIG. 4 adopting battery cell units 111 in the shape of square column.

Based on the above, in the battery pack of the disclosure, the packaging material is tightly bonded to the battery cell units to prevent the battery cell units from moving relative to each other, thereby guaranteeing the reliability of the connections between the battery cell units and the conductive units and further improving the electricity supply performance and safety. In another respect, the packaging material tightly contacts the battery cell units., which also reduces the thermal resistance and improves the heat dissipating efficiency.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

1. A battery pack, comprising:
multiple battery cell units;
multiple conductive units, electrically connected to the battery cell units;
one or more packaging materials, filling the gaps between the battery cell units and being in immediate contact with surfaces of the battery cell units; and
a grid for improving heat conduction, buried in the one or more packaging materials, wherein each mesh of the grid is configured with one of the battery cell units.

2. The battery pack according to claim 1, wherein components of the one or more packaging materials comprise reactive resin.

3. The battery pack according to claim 2, wherein the components of the one or more packaging materials further comprise a Phase Change Material (PCM) microcapsule.

4. The battery pack according to claim 2, wherein the components of the one or more packaging materials further comprise structure strengthening fibres.

5. The battery pack according to claim 2, wherein the components of the one or more packaging materials further comprise elastic particles.

6. The battery pack according to claim 2, wherein the reactive resin comprises epoxy resin, unsaturated polyester, vinylester, polyurethane, or phenolic resin.

7. The battery pack according to claim 1, further comprising at least one gap control member, configured between the battery cell units.

8. The battery pack according to claim 1, wherein each of the conductive units comprises multiple metal sheets welded and connected the battery cell units.

9. (canceled)

10. The battery pack according to claim 1, further comprising a housing heatsink, connected to the grid.

11. The battery pack according to claim 1, wherein the battery cell units are in a shape of a cylinder or a square column, a total general thickness of the one or more packaging materials between the battery cell units is larger than or equal to 50% of a height of the battery cell units.
